(19) United States
(12) Patent Application Publication
(10) Pub. No.: US 2018/0321099 A1
(43) Pub. Date: Nov. 8, 2018

(54) Measuring device and method for ascertaining operating parameters at shafts

(71) Applicant: Schaeffler Technologies AG & Co. KG, Herzogenaurach (DE)

(72) Inventors: Christoph Weeth, Bergrheinfeld (DE); Frank Benkert, Waigolshausen (DE)

(73) Assignee: Schaeffler Technologies AG & Co. KG, Herzogenaurach (DE)

(21) Appl. No.: 15/771,851

(22) PCT Filed: Jan. 31, 2017
(86) PCT No.: PCT/DE2017/100062

§ 371 Date: Apr. 27, 2018

(30) Foreign Application Priority Data
Feb. 1, 2016 (DE) 10 2016 201 455.2

(51) Int. Cl. G01L 5/13; G01L 5/22

(52) U.S. Cl. CPC G01L 5/136; G01L 3/24; G01L 5/225

(57) ABSTRACT

Measuring devices and methods for ascertaining an operating parameter at a shaft are disclosed. The shaft may be supported by at least one bearing. In one example, the measuring device includes at least one first sensor element configured to detect an absolute angle of the shaft and at least one second sensor element configured to detect a change in a distance of the shaft from the at least one second sensor element. A computing device may be configured to calculate one or more operating parameters at the shaft from the absolute angle of the shaft and the change in the distance.

### CROSS-REFERENCE TO RELATED APPLICATIONS

This application is the U.S. National Phase of PCT Appln. No. PCT/DE2017/100062 filed Jan. 31, 2017, which claims priority to DE 102016201455.2 filed Feb. 1, 2016, the entire disclosures of which are incorporated by reference herein.

### TECHNICAL FIELD

The present disclosure relates to a measuring device and a method for ascertaining operating parameters at a shaft, for example, the shaft of a bottom bracket bearing arrangement of a bicycle or electric bicycle.

### BACKGROUND

In motor-assisted bicycles, frequently also called pedelecs or electric bicycles, an electric motor contributes force for the forward drive. This force assists at least the pedal force of the rider. The pedal force is introduced into a bottom bracket bearing via a crank and normally varies. Therefore, in order, for example, that a predetermined constant speed can be maintained, the measurement of the torque on the bottom bracket shaft is required for the drive control of the motor.

Even in bicycles without motor assistance, it is frequently of interest, for example, to ascertain and indicate the power introduced by the rider.

EP 0 983 934 B1 discloses a torque sensor with which a torque applied to a bottom bracket shaft, for example a bottom bracket shaft of an electric bicycle, can be ascertained. The torque sensor comprises a pressure sensor element, which is arranged on a sensor carrier and is fitted with a force fit between the bottom bracket shaft and a portion of a bicycle frame that encloses the bottom bracket shaft. The force measurement is therefore carried out substantially on the outer ring of a bearing supporting the bottom bracket shaft. The pressure sensor element registers a value of a force on the bottom bracket shaft, which can be proportional to a torque on the bottom bracket shaft.

Leading on from EP 0 983 934 B1, DE 103 39 304 A1 discloses a sensor carrier for transmitting a force from a bottom bracket shaft to a sensor element. The sensor carrier comprises a radially inner part and a radially outer part, wherein one of the parts has an elevation, for example an element projecting out of the surface of the part, for deforming the other part. When a force acts on the bottom bracket shaft and thus there is a transfer of force to the sensor carrier, the elevation is deformed. Given a known relationship between the deformation and the force on the bottom bracket shaft that effects the deformation, this force can be ascertained from the deformation. The torque can then be ascertained indirectly via the length measurement of the deformation, for example the length measurement by a strain gage.

Also known are torque sensors based on the principle of inverse magnetostriction, see, for example, U.S. Pat. No. 5,351,555 and U.S. Pat. No. 5,520,059. Here, a magnetic field is introduced permanently into a bottom bracket shaft. An action of force on the bottom bracket shaft causes a change in the magnetic field. This change can be measured by appropriate sensors, and thus the torque can be ascertained.

### SUMMARY

An object of the disclosure is to specify a measuring device for ascertaining operating parameters at a shaft, such as the torque or the power on a bottom bracket shaft of a bicycle or electric bicycle, which structurally and/or functionally improves the measuring devices mentioned at the beginning or provides an alternative thereto. The measuring device is intended to be substantially capable of integration in the standard installation space of such a bottom bracket bearing arrangement. Furthermore, it is an object of the disclosure to permit the components of the motor drive, such as the drive control of the electric motor, an optimal reaction time for the control of the auxiliary force. It is also an object of the disclosure to indicate to the user of a bicycle or electric bicycle their introduced power, for example.

This object may be achieved according to the disclosure by the described measuring device and a method for ascertaining an operating parameter at a shaft. The shaft is supported by at least one bearing and, in particular, can be the shaft of a bottom bracket bearing arrangement of a bicycle or electric bicycle.

Accordingly, the measuring device comprises at least one first sensor element for detecting the absolute angle of the shaft and at least one second sensor element for detecting a change in the distance of the shaft from the aforementioned second sensor element.

A change in the distance of the shaft can occur as a result of a deflection of the shaft, for example on account of a load which acts on one end of the shaft. A change in the distance of the shaft can, however, also occur as a result of a displacement of the shaft. A displacement of the shaft is normally brought about by the bearing operating play or the spring deflection of the shaft in a rolling-contact bearing.

With the disclosure, operating parameters, such as the torque and the power, can thus advantageously be ascertained with two sensor elements. This is because a force F_p introduced via a crank arm can be broken down into a tangential force F_t and a radial force F_r. The radial force F¬_r is frequently also designated as a normal force. The line of action of the radial force F_r is directed toward the center of the shaft and simultaneously forms a right angle with the line of action of the tangential force F_t. The change in the distance that is detected is related directly to the force F_p. Thus, the force F_p can be ascertained from the detected measured value from the at least one second sensor element.

It is thus true for the ascertainment of the tangential force F_t that:

F_t=F_p*sin(beta), where beta is the detected absolute angle of the shaft from the at least one first sensor element, and the force F_p results from the detected change in the distance.

From the tangential force F_t, it is in turn possible to ascertain the torque or the power on the shaft, for example directly. The disclosure therefore advantageously uses simple and reliable measuring principles, additionally requiring little installation space, in order to draw conclusions about the torque or the power on a shaft. Furthermore, via the continuous measurement of the absolute angle of the shaft, the direction of rotation of the shaft can be ascertained more quickly than in conventional applications with relative angle measurement. For the components of an electric drive, such as the drive control of an electric motor, this permits an optimal reaction time for controlling the auxiliary force to be introduced. Furthermore, the detection of the absolute angle beta of the shaft permits the position of the left-hand and/or the right-hand pedal crank of a bicycle to be ascertained.

In one embodiment, the at least one first sensor element or the at least one second sensor element is formed as an eddy current sensor. Eddy current sensors are non-contacting distance sensors that are substantially insensitive with respect to media such as oil, water and dust in the measuring gap. In one embodiment, both sensor elements are formed as eddy current sensors.

In a further embodiment, the at least one first sensor element and the at least one second sensor element are integrated structurally in one sensor unit. For example, two coils can be arranged on a sensor unit, which, in accordance with the eddy current principle, firstly detect the absolute angle and secondly the change in the distance. A particularly advantageous embodiment of the sensor unit comprises four coils, in order to detect the absolute angle measurement and the change in the distance repeatedly and therefore to be able to carry out a more accurate calculation of the values.

In one embodiment of the measuring device according to the disclosure, for the detection of the absolute angle, an encoder is arranged radially on the shaft or radially on a component rotationally fixedly connected to the shaft, in particular on an extension of an inner ring of the bearing. This embodiment advantageously permits the detection of the absolute angle within the bottom bracket bearing arrangement, that is to say in the protected installation space of the bottom bracket bearing arrangement.

In a further embodiment of the measuring device according to the disclosure, for the detection of the absolute angle, an encoder is arranged axially on the shaft or axially on a component rotationally fixedly connected to the shaft, in particular on an inner ring of the bearing or a seal of the bearing. This embodiment advantageously permits the detection of the absolute angle, for example on an axial surface of the shaft or an inner ring of the bottom bracket bearing arrangement, and can thus be simply retrofitted, such as, for example, in bottom bracket bearings having bearing shells attached to the frame. Furthermore, the axial configuration of the encoder can particularly advantageously be appropriately chosen to be so thin that the encoder is not influenced substantially by effects of the displacement of the shaft. Expressed in other words, the physical detection of the first sensor element can be chosen to be so much wider that the correspondingly thinner configured encoder always remains within the detection range of the first sensor element, despite the displacement effects in the shaft.

The axial or radial encoder can be formed as a central, eccentric or sinusoidal wedge. Binary encoding is also possible. Thus, the two binary values can be formed, for example, by different materials, such as copper and non-copper, or a change in the geometry of the encoder, such as elevation and depression.

In one embodiment of the measuring device according to the disclosure, the at least one bearing has a bearing point, wherein the at least one second sensor element is arranged at the bearing point. An arrangement on or close to the bearing point permits the measurement of the change in the distance which is caused by a displacement of the shaft at the bearing point. Thus, inter-alia, it is possible better to draw conclusions about the operating parameter which is introduced at the bearing point with the corresponding bottom bracket bearing crank.

In a further embodiment of the measuring device according to the disclosure, the at least one bearing has a first and a second bearing point, and the measuring device comprises at least two second sensor elements, wherein one each of the second sensor elements is arranged at the first and the second bearing point. Thus, the operating parameter is introduced at the respective bearing point, that is to say, for example, with the left-hand or right-hand bottom bracket bearing crank of a bicycle, can be ascertained.

In one embodiment of the measuring device according to the disclosure, the at least one bearing has a first and a second bearing point, wherein the at least one second sensor element is arranged between the first and the second bearing point. This permits, for example, the total moment or the total power of a right-hand and left-hand bottom bracket bearing crank to be ascertained. A central arrangement of the at least one second sensor element is particularly advantageous, since the greatest deflection of the shaft occurs here. Furthermore, the at least one second sensor element can be arranged off-center, and oriented at an angle to the shaft in such a way that it is able to detect the greatest shaft deflection.

In one embodiment, the measuring device according to the disclosure comprises at least two second sensor elements, wherein the at least two second sensor elements are arranged to be offset radially by 180 degrees around the shaft. When the shaft is loaded, the one second sensor element thus comes closer to the shaft and the other second sensor element simultaneously moves away from the shaft. This permits the values ascertained to be checked for plausibility.

In one embodiment of the measuring device according to the disclosure, the at least one first sensor element and the at least one second sensor element detect their respective measured variable simultaneously.

The measuring device according to the disclosure further comprises a computing device. The computing device calculates the operating parameter, in particular the torque or the power, with the aid of the detected measured values. The operating parameter can be made available as an electric signal for further applications.

In one embodiment, the measuring device according to the disclosure comprises an energy generating unit. This energy generating unit permits autonomous operation of the measuring device, in particular the computing device. Moreover, with the available energy, it is possible to forward data via a wire-free connection, such as Bluetooth or other radio standards, for example. Thus, the measuring device can be formed to be completely closed and protected well against external environmental influences. An energy generating unit is, for example, a claw-pole generator integrated into the bearing. Alternatively, a power source, for example a rechargeable battery, can also be integrated into the installation space of the bearing or arranged in the physical vicinity.

The previously described embodiments of the measuring device according to the disclosure assume that the sensor elements or sensor units are arranged on a stationary part, for example a bearing housing, and an encoder or the shaft itself are arranged on the rotating part or is the latter itself. Likewise covered by the disclosure is a converse arrangement. The sensor elements or sensor units can therefore also be arranged on the rotating part, such as the shaft. Then, a change in the distance of the shaft from a fixed reference point can likewise be ascertained, or an encoder for the detection of the absolute angle can be arranged fixedly on a non-rotating part. The signals can be transmitted onward, for example by radio.

Also comprised by the disclosure are a bottom bracket bearing arrangement with a measuring device as described above and below, and a bicycle, in particular an electric bicycle, having such a bottom bracket bearing arrangement.

The disclosure also comprises a method for ascertaining an operating parameter, in particular a torque or a power, at a shaft, in particular the shaft of a bottom bracket bearing arrangement of a bicycle or electric bicycle, wherein a force F_p can be introduced into the shaft via at least one pedal crank, wherein the force F_p can be broken down into a tangential force F_t and a radial force F_r, wherein the line of action of the radial force F_r is directed toward the center of the shaft, and wherein the line of action of the tangential force F_t forms a right angle with the line of action of the radial force F_r, comprising: detecting the absolute angle beta of the shaft, detecting a change in the distance of the shaft from a specific part, in particular a sensor element, and calculating the operating parameter at the shaft from the absolute angle beta and the change in the distance, wherein the force F_p can be calculated from the change in the distance, wherein the tangential force F_t can be calculated from the force F_p and the absolute angle beta, and wherein the operating parameter at the shaft is determined by the tangential force F_t.

Further advantages, features and details of the disclosure can be gathered from the example embodiment described below and by using the drawings.

### BRIEF DESCRIPTION OF THE DRAWINGS

In the following, an example embodiment of the disclosure will be illustrated using the figures. The figures show non-scaled drawings, in which:

FIG. 1 shows a basic sketch of forces acting in a bottom bracket bearing arrangement,

FIG. 2 shows possible codes for a radial and an axial encoder for detecting the absolute angle of a shaft, and

FIG. 3 shows a basic illustration relating to detecting the deflection of a shaft of a bottom bracket bearing arrangement.

### DETAILED DESCRIPTION

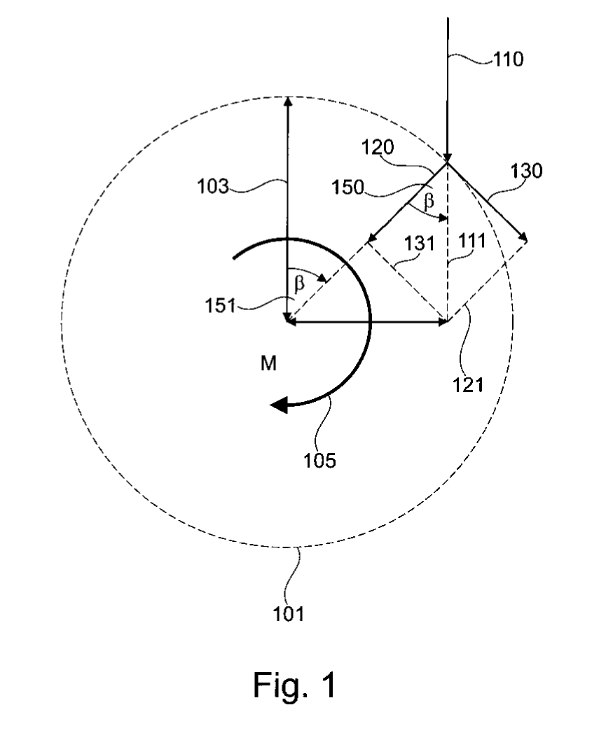

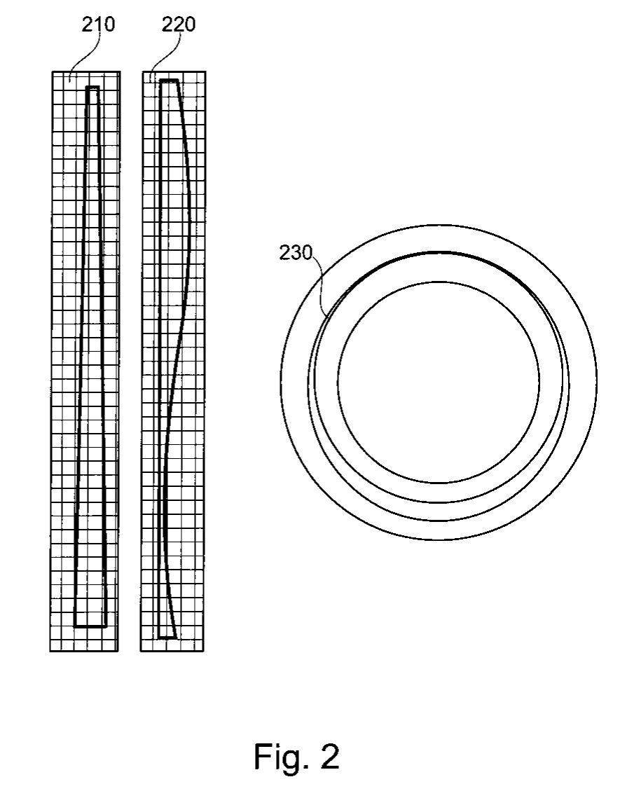

FIG. 1 shows a basic sketch of forces acting in a bottom bracket bearing arrangement. The dashed circular line 101 shows the circular path of a crank pedal (not shown) of a crank arm (not shown) around the center M of a bottom bracket shaft (not shown). The circle related to the circular line 101 has the radius 103. The pedal force F_p 110 is introduced into the bottom bracket shaft via the crank pedal and the crank arm. The direction 105 shows the direction of circulation of the crank pedal and of the crank arm about the bottom bracket shaft. Expressed in other words, it shows the direction of the circulation of an introduction of force along the circular line 101 (however, the vector direction of the actual pedal force is not to be understood hereby). The pedal force F_p 110 can be broken down into a radial force F_r 120 and a tangential force F_t 130. Radial force F_r 120 and tangential force F_t 130 are at right angles to each other. The absolute angle beta results from the force parallelogram consisting of the designations 120, 121, 130, 131 and of the projected force vector of the pedal force F_p 111. This angle beta 150 is identical to the absolute angle beta 151 of the crank arm with the radius line 103 illustrated. This radius line 103 extends parallel to the vector direction of the pedal force F_p 110. Thus, by measuring the actual absolute angle beta 151 of the crank arm, the absolute angle beta 150 in the force parallelogram can also be ascertained. Such an actual measurement of the actual absolute angle beta 151 is possible, for example, by using a sensor element such as an eddy current sensor for detecting an encoder on the bottom bracket bearing shaft having a code according to FIG. 2.

FIG. 2 shows possible codes for a radial and an axial encoder for detecting the absolute angle of a shaft. Thus, a wedge-shaped code 210 and a sinusoidal code 220 for a radial encoder are illustrated. A corresponding variant 230 for an axial code is also shown for an axial encoder.

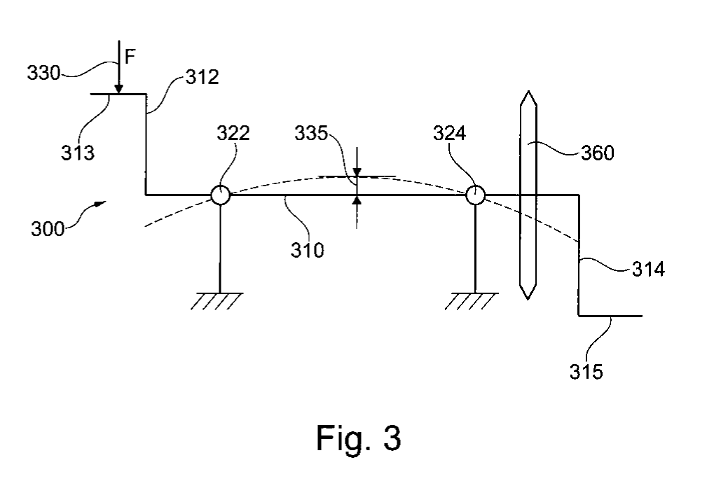

FIG. 3 shows a basic illustration relating to the detection of the deflection of a shaft 310 of a bottom bracket bearing arrangement 300. The shaft 310 is rotationally fixedly connected at its axial ends to a first crank arm 312 and a second crank arm 314. The first crank arm 312 has a pedal axis 313, the second crank arm 314 correspondingly has a pedal axis 315. The shaft 310 is mounted via a first bearing point 322 and a second bearing point 324. A pedal force F_p, which can be introduced into the shaft 310, for example by crank pedals on the pedal axes 313, 315 via the first and second crank arm, leads to deflection and displacement of the shaft 310. The deflection is illustrated by the dashed line 335. Such bending of the shaft 310 leads, for example, to a change in the eddy currents in an eddy current measurement (not illustrated). The torque acting on the shaft 310 is transferred to the chain ring 360 rotationally fixedly connected to the shaft 310.

### LIST OF DESIGNATIONS

101 Circular line of a circle
103 Radius of the circle
105 Direction of circulation of an introduction of force along the circular line
M Center of the circle
110, 111 Pedal force/force F_p
120, 121 Radial force F_r
130, 131 Tangential force F_t
150 Absolute angle beta
210 Wedge-shaped code for radial encoder
220 Sinusoidal code for radial encoder
230 Code for axial encoder
300 Bottom bracket bearing arrangement
310 Shaft
312 Left-hand crank arm
313 Left-hand pedal axis
314 Right-hand crank arm
315 Right-hand pedal axis
322 Left-hand bearing point
324 Right-hand bearing point
330 Force F
335 Possible deflection of the shaft upon introduction of force
360 Chain ring

1. A measuring device for ascertaining an operating parameter at a shaft, the shaft being supported by at least one bearing, the measuring device comprising:
at least one first sensor element configured to detect an absolute angle of the shaft;
at least one second sensor element configured to detect a change in a distance of the shaft from the at least one second sensor element; and
a computing device configured to calculate one or more operating parameters at the shaft from the absolute angle of the shaft and the change in the distance.

2. The measuring device as claimed in claim 1, wherein, for the detection of the absolute angle, an encoder is arranged radially on the shaft or radially on a component rotationally fixedly connected to the shaft.

3. The measuring device as claimed in claim 2, wherein the rotationally fixedly connected component is an extension of an inner ring of the bearing.

4. The measuring device as claimed in claim 1, wherein, for the detection of the absolute angle, an encoder is arranged axially on the shaft or axially on a component rotationally fixedly connected to the shaft.

5. The measuring device as claimed in claim 4, wherein the rotationally fixedly connected component is an inner ring of the bearing or a seal.

6. The measuring device as claimed in claim 1, wherein the at least one bearing has a bearing point, and wherein the at least one second sensor element is arranged at the bearing point.

7. The measuring device as claimed in claim 1, wherein the at least one bearing has a first and a second bearing point, wherein the measuring device comprises at least two second sensor elements, and wherein one each of the second sensor elements is arranged at the first and the second bearing point.

8. The measuring device as claimed in claim 1, wherein the at least one bearing has a first and a second bearing point, and wherein the at least one second sensor element is arranged between the first and the second bearing point.

9. The measuring device as claimed in claim 8, wherein the at least one second sensor element is arranged centrally between the first and the second bearing point.

10. The measuring device as claimed in claim 1, wherein the at least one first sensor element and/or the at least one second sensor element are/is formed as an eddy current sensor.

11. The measuring device as claimed in claim 1, wherein the at least one first sensor element and the at least one second sensor element are integrated structurally in one sensor unit.

12. A method for ascertaining an operating parameter at a shaft,
wherein a force can be introduced into the shaft via at least one crank arm rotationally fixedly connected to the shaft,
wherein the force can be broken down into a tangential force and a radial force,
wherein a line of action of the radial force is directed toward a center of the shaft,
and wherein a line of action of the tangential force forms a right angle with the line of action of the radial force,
the method comprising:
detecting an absolute angle of the shaft;
detecting a change in a distance of the shaft from a sensor element; and
calculating the operating parameter at the shaft from the absolute angle and the change in the distance, wherein the force is calculated from the change in the distance, wherein the tangential force is calculated from the force and the absolute angle, and wherein the operating parameter at the shaft is determined by the tangential force.

13. A measuring device for ascertaining a torque or a power at a shaft of a bottom bracket bearing arrangement of a bicycle or electric bicycle, the shaft being supported by a bearing, the measuring device comprising:
a first sensor element configured to detect an absolute angle of the shaft;
a second sensor element configured to detect a change in a distance of the shaft from the second sensor element; and
a computing device configured to calculate the torque or the power at the shaft from the absolute angle of the shaft and the change in the distance.

14. The measuring device as claimed in claim 13, wherein, for the detection of the absolute angle, an encoder is arranged radially on the shaft or radially on a component rotationally fixedly connected to the shaft.

15. The measuring device as claimed in claim 13, wherein, for the detection of the absolute angle, an encoder is arranged axially on the shaft or axially on a component rotationally fixedly connected to the shaft.

16. The measuring device as claimed in claim 13, wherein the bearing has a bearing point, and wherein the second sensor element is arranged at the bearing point.

17. The measuring device as claimed in claim 13, wherein the bearing has a first and a second bearing point, wherein the measuring device comprises at least two second sensor elements, and wherein one each of the second sensor elements is arranged at the first and the second bearing point.

18. The measuring device as claimed in claim 13, wherein the bearing has a first and a second bearing point, and wherein the second sensor element is arranged between the first and the second bearing point.

19. The measuring device as claimed in claim 13, wherein the first sensor element and/or the second sensor element are/is formed as an eddy current sensor.

20. The measuring device as claimed in claim 13, wherein the first sensor element and the second sensor element are integrated structurally in one sensor unit.
